(19) United States
(12) Patent Application Publication
(10) Pub. No.: US 2024/0112207 A1
(43) Pub. Date: Apr. 4, 2024

(54) METHOD FOR CLUSTERING PLACES OF INTEREST USING SEGMENT CHARACTERIZATION AND COMMON EVENING LOCATIONS OF ENTITIES

(71) Applicant: Near Intelligence Holdings, Inc., Pasadena, CA (US)

(72) Inventors: G Vamsi Sai Krishna Murthy, Bangalore (IN); Hari Palappetty, Bangalore (IN); Sumanth N, Bangalore (IN); Aadhaar Aggarwal, Bangalore (IN)

(21) Appl. No.: 17/958,376

(22) Filed: Oct. 1, 2022

(51) Int. Cl. G06Q 30/0201

(52) U.S. Cl. CPC G06Q 30/0201

(57) ABSTRACT

A method of clustering of one or more place of interest (POIs) using segment characterization and common evening locations of one or more entities. The method includes (i) generating, using location data streams associated with entities, a location mapping of the entities with a geographical area that provides ambient population of the geographical area and common evening location of the entities, (ii) determining, for the POIs, visitor entities to record a footfall of the POIs, (iii) dynamically assigning catchment areas for the POIs using the footfall and location mapping, (iv) determining segments of the visitor entities for POIs based on offline and online behaviour of visitor entities, (v) automatically approximating an error in the footfall to obtain an improved footfall of the POIs, and (v) determining segment opportunity value for the POIs, and clustering the POIs that have similar catchment areas based on segment potential value and the improved footfall.

### BACKGROUND

### Technical Field

The embodiments herein relate to clustering geographical locations, and more specifically to clustering of places of interests (PO's) using segment characterization, and common evening locations of entities.

### Description of the Related Art

The COVID pandemic has significantly changed behavior of the consumers to a new normal, and organizations have witnessed a major upheaval in determining the behaviour patterns and journey of the users of the stores. In this regard, users vicinity shopping and dwell time in engaging with the brand has drastically changed. Henceforth, predicting the retail potential for a given store is required to get a complete picture of both people and places in a given geography.

With the ever-increasing digitization and usage of smart mobile applications, users are generating a large amount of internet traffic data. The internet traffic data may be an indicator of the location of the users at a given time frame. A variety of different events associated with the users are encoded in many data formats, recorded, and transmitted in a variety of data streams depending on the nature of the device. Smart mobile applications, when engaged with a user, generate an event that produces data streams with device identifiers that are an integral part of the smartphone ecosystem and smart mobile applications economy.

Further, the data streams are from independently controlled sources. The independently controlled sources are sources of the data stream that control a variety of aspects such as the attributes which are collected, frequency and means of data being collected, the format of data, format of populating the data stream, and types of identifiers used.

Accordingly, there remains a need for a more efficient system and method for mitigating and/or overcoming drawbacks associated with current methods.

### SUMMARY

In view of the foregoing, an embodiment herein provides a method of clustering of one or more places of interests (POIs) using segment characterization and common evening locations of one or more entities. The method includes (a) generating, using one or more location data streams that are associated with the one or more entities, a location mapping of the one or more entities with a geographical area, the location mapping provides an ambient population of the geographical area and a common evening location of the one or more entities, (b) determining, for each of the one or more POIs, visitor entities among the one or more entities to record a footfall of each of the one or more POIs, the visitor entities of a POI are the entities that visit the POI, (c) dynamically assigning catchment areas for each of the one or more POIs using the footfall and the location mapping, (d) determining segments of the visitor entities for each of the one or more POIs based on an offline behaviour and an online behaviour of the visitor entities, (e) automatically approximating an error in the footfall to improve a footfall model, the footfall model estimates a threshold that offsets the footfall to obtain an improved footfall of each of the plurality of POIs, (f) determining a segment opportunity value for each of the one or more POIs, the segment opportunity value is a function of (i) the improved footfall, (ii) the ambient population of each of the plurality of POIs, (iii) the segments of the visitor entities and (iv) nearby POIs, and (g) clustering the plurality of POIs that have similar catchment areas based on the segment potential value and the improved footfall.

In some embodiments, the one or more location data streams are obtained from independently controlled data sources, the location data streams include a real-time event with additional information including device attributes, connection attributes, and user agent strings.

In some embodiments, the method further includes (a) generating a list of unique visitor entities for each of the plurality of POIs, and (b) assigning catchment areas based on the common evening location of the list of unique visitor entities, average distance travelled by the list of unique visitor entities to visit each of the plurality of POIs and POIs nearby to the common evening location of the list of unique visitor entities.

In some embodiments, the method further includes (a) generating a list of unique non-visitors that have not visited the plurality of POIs or are repeat visitors of the plurality of POIs, and (b) updating the improved footfall using the list of unique non-visitors based on the catchment areas.

In some embodiments, the method further includes eliminating a bias in the footfall model, the bias is introduced due to a business size of a POI that causes a POI with lower improved footfall to have a lower segment potential value.

In some embodiments, the segment opportunity value for each of the one or more POIs is determined using a drive distance of the visitor entities to each of the one or more POIs, the improved footfall, a dwell-time of the visitor entities in each of the one or more POIs, a visit frequency, a segment characteristic of the segments of the visitor entities and the common evening locations of the visitor entities.

In some embodiments, the method further includes determining the segment opportunity value for each of the plurality of POIs using a weighted average approach based on attributes of the one or more entities, the attributes include a distance travelled attribute, an affinity attribute, a purchase window attribute, an income attribute, and an age attribute.

In another aspect, there is provided a place of interest (POI) clustering server that clusters one or more POIs using segment characterization and common evening locations of one or more entities. The POI clustering server includes a processor and a memory that stores a set of instructions, which when executed by the processor, causes to perform: (a) generating, using one or more location data streams that are associated with the one or more entities, a location mapping of the one or more entities with a geographical area, the location mapping provides an ambient population of the geographical area and a common evening location of the one or more entities, (b) determining, for each of the one or more POIs, visitor entities among the one or more entities to record a footfall of each of the one or more POIs, the visitor entities of a POI are the entities that visit the POI, (c) dynamically assigning catchment areas for each of the one or more POIs using the footfall and the location mapping. (d) determining segments of the visitor entities for each of the one or more POIs based on an offline behaviour and an online behaviour of the visitor entities, (e) automatically approximating an error in the footfall to improve a footfall model, the footfall model estimates a threshold that offsets the footfall to obtain an improved footfall of each of the plurality of POIs, (f) determining a segment opportunity value for each of the one or more POIs, the segment opportunity value is a function of (i) the improved footfall, (ii) the ambient population of each of the one or more POIs, (iii) the segments of the visitor entities and (iv) nearby POIs, and (g) clustering the one or more POIs that have similar catchment areas based on the segment potential value and the improved footfall.

In some embodiments, the one or more location data streams are obtained from independently controlled data sources, the location data streams include a real-time event with additional information including device attributes, connection attributes, and user agent strings.

In some embodiments, the POI clustering server further includes (a) generating a list of unique visitor entities for each of the plurality of POIs, and (b) assigning catchment areas based on the common evening location of the list of unique visitor entities, average distance travelled by the list of unique visitor entities to visit each of the one or more POIs and POIs nearby to the common evening location of the list of unique visitor entities.

In some embodiments, the POI clustering server further includes (a) generating a list of unique non-visitors that have not visited the one or more POIs or are repeat visitors of the one or more POIs, and (b) updating the improved footfall using the list of unique non-visitors based on the catchment areas.

In some embodiments, the POI clustering server further includes eliminating a bias in the footfall model, the bias is introduced due to a business size of a POI that causes a POI with lower improved footfall to have a lower segment potential value.

In some embodiments, the segment opportunity value for each of the one or more POIs is determined using a drive distance of the visitor entities to each of the one or more POIs, the improved footfall, a dwell-time of the visitor entities in each of the one or more POIs, a visit frequency, a segment characteristic of the segments of the visitor entities and the common evening locations of the visitor entities.

In some embodiments, the POI clustering server further includes determining the segment opportunity value for each of the one or more POIs using a weighted average approach based on attributes of the one or more entities, the attributes include a distance travelled attribute, an affinity attribute, a purchase window attribute, an income attribute, and an age attribute.

In another aspect, there is provided one or more non-transitory computer-readable storage mediums storing the one or more sequences of instructions, which when executed by the one or more processors, causes clustering of one or more places of interests (POIs) using segment characterization and common evening locations of one or more entities by (a) generating, using one or more location data streams that are associated with the one or more entities, a location mapping of the plurality of entities with a geographical area, the location mapping provides an ambient population of the geographical area and a common evening location of the one or more entities, (h) determining, for each of the one or more POIs, visitor entities among the one or more entities to record a footfall of each of the one or more POIs, the visitor entities of a POI are the entities that visit the POI, (c) dynamically assigning catchment areas for each of the one or more POIs using the footfall and the location mapping, (d) determining segments of the visitor entities for each of the one or more POIs based on an offline behaviour and an online behaviour of the visitor entities, (e) automatically approximating an error in the footfall to improve a footfall model, the footfall model estimates a threshold that offsets the footfall to obtain an improved footfall of each of the one or more POIs, (f) determining a segment opportunity value for each of the one or more POIs, the segment opportunity value is a function of (i) the improved footfall, (ii) the ambient population of each of the plurality of POIs, (iii) the segments of the visitor entities and (iv) nearby POIs, and (g) clustering the one or more POIs that have similar catchment areas based on the segment potential value and the improved footfall.

In some embodiments, the one or more location data streams are obtained from independently controlled data sources, the location data streams include a real-time event with additional information including device attributes, connection attributes, and user agent strings.

In some embodiments, the sequence of instructions further includes (a) generating a list of unique visitor entities for each of the one or more POIs, and (b) assigning catchment areas based on the common evening location of the list of unique visitor entities, average distance travelled by the list of unique visitor entities to visit each of the one or more POIs and POIs nearby to the common evening location of the list of unique visitor entities.

In some embodiments, the sequence of instructions further includes (a) generating a list of unique non-visitors that have not visited the one or more POIs or are repeat visitors of the one or more POIs, and (b) updating the improved footfall using the list of unique non-visitors based on the catchment areas.

In some embodiments, the sequence of instructions further includes eliminating a bias in the footfall model, the bias is introduced due to a business size of a POI that causes a POI with lower improved footfall to have a lower segment potential value.

In some embodiments, the sequence of instructions further includes determining the segment opportunity value for each of the one or more POIs using a weighted average approach based on attributes of the one or more entities, the attributes include a distance travelled attribute, an affinity attribute, a purchase window attribute, an income attribute, and an age attribute.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a schematic illustration of a system for clustering of one or more places of interests (POIs) using segment characterization and common evening locations of a plurality of entities according to some embodiments herein;

FIG. 2 is a block diagram of a POI clustering server of FIG. 1 according to some embodiments herein;

FIG. 3A is a two-dimensional scatter plot that illustrates footfall vs segment opportunity value for the plurality of POIs, according to some embodiments herein;

FIG. 3B is a two-dimensional scatter plot that illustrates footfall vs distance travelled for the plurality of POIs, according to some embodiments herein;

FIG. 4 illustrates an interaction diagram of a method for clustering of one or more places of interests (POIs) using segment characterization and common evening locations of a plurality of entities according to some embodiments herein;

FIGS. 5A and SB are flow diagrams of a method for clustering of one or more places of interests (POIs) using segment characterization and common evening locations of a plurality of entities according to some embodiments herein; and

FIG. 6 is a schematic diagram of a computer architecture of the unique generated identifier server or one or more devices in accordance with embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

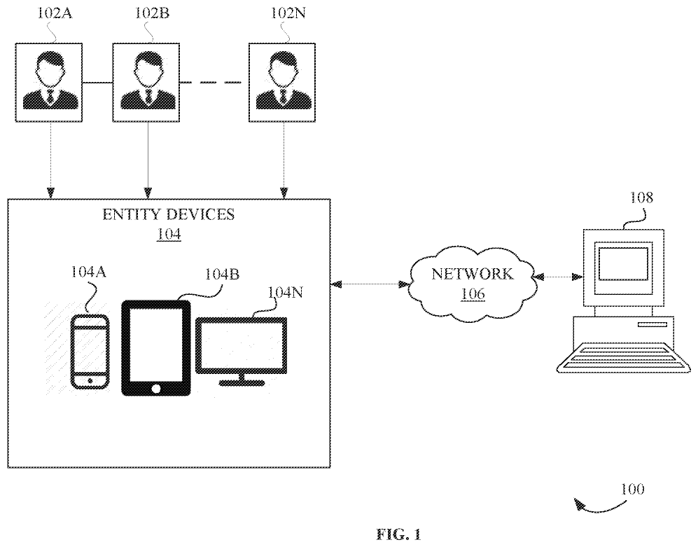

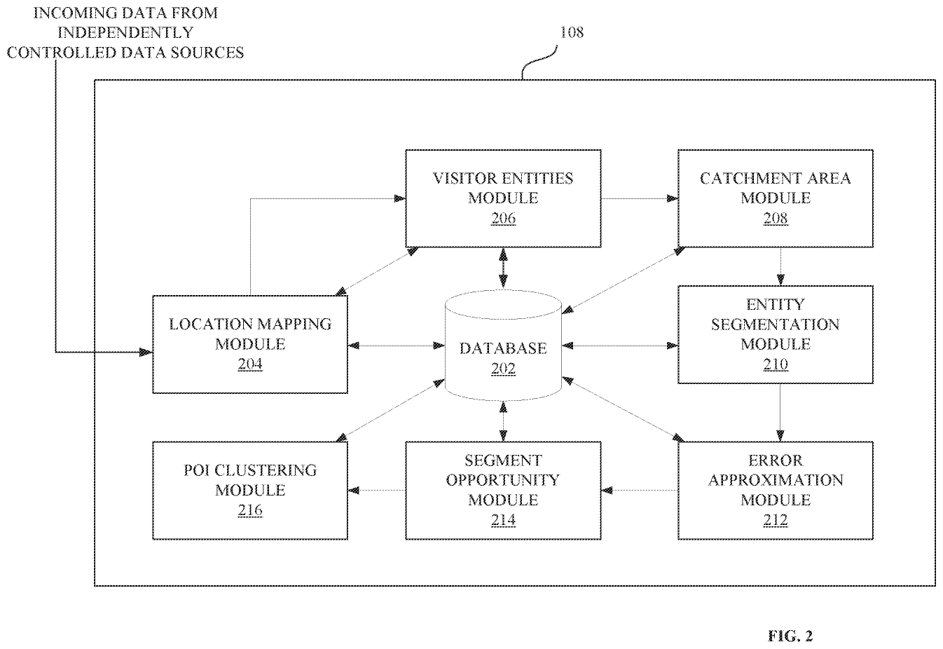

There remains a need for a system and method for clustering geographical locations, and more specifically, for an automatic system and method for clustering of one or more places of interests (POIs) using segment characterization and common evening locations of a plurality of entities. Referring now to the drawings, and more particularly to FIGS. 1 to 6, where similar reference characters denote corresponding features consistently throughout the figures, there are shown preferred embodiments.

The term “independently controlled data sources” refers to any source that may control or standardize different aspects of data streams. The different aspects include, but is not limited to, (1) a type of data that needs to be collected, (2) a time and location of the data need to be collected, (3) a data collection method, (4) modification of collected data, (5) a portion of data to be revealed to the public, (6) a portion of the data to be protected, (7) a portion of data that can be permitted by a consumer or a user of an application or the device, and (8) a portion of data to be completely private. The terms “consumer” and “user” may be used interchangeably and refer to an entity associated with a network device or an entity device.

A single real-world event may be tracked by different independently controlled data sources. Alternatively, data from the different independently controlled data sources may be interleaved to understand an event or a sequence of events. For example, consider the consumer using multiple applications on his smartphone, as he or she interacts with each application, multiple independent data streams of the sequence of events may be produced. Each application may become an independent data source. Events and users may have different identifiers across different applications depending on how the application is implemented. Additionally, if one were to monitor a network, each application-level event may generate additional lower-level network events.

In an exemplary embodiment, various modules described herein and illustrated in the figures are embodied as hardware-enabled modules and may be configured as a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that are configured with electronic circuits process computer logic instructions capable of providing at least one of digital signals or analog signals for performing various functions as described herein.

FIG. 1 is a schematic illustration of a system 100 for clustering of one or more places of interests (PO's) using segment characterization and common evening locations of one or more entities 102A-N according to some embodiments herein. The term “location” refers to a geographic location that includes a latitude-longitude pair and/or an altitude. The location may include a locality, a sub locality, an establishment, a geocode, or an address. The location may be any geographic location on land or sea. The system 100 includes one or more entity devices 104A-N associated with one or more entities 102A-N, and a POI clustering server 108. The one or more entity devices 104A-N include one or more smart mobile applications. The one or more entity devices 104A-N are communicatively connected to the POI clustering server 108 through a network 106. In some embodiments, the one or more entities 102A-N are a set of individuals whose activity on the one or more entity devices 104A-N generate location data streams that may be used for identifying the entity device using the device signature of the entity device and the location signature of the location.

The device signature may refer to a hashed identifier (a unique, non-sequential identifier) that may be generated using one or more device attributes. An example of the device signature may be “256353902131466809”. The one or more device attributes describes the entity device 104A and may be configured during the manufacturing process of the entity device 104A itself. The one or more device attributes may include, but not be limited to, a make attribute, a model number attribute for a particular group of entity devices, an operating system, a device screen size, and other suitable data related to the one or more entity devices 104A-N. For example, the plurality of device attributes may be (a) “Samsung, SM-A715F, Android,1080x2400”, (b) “Samsung|SM-N960U|Android”, (c) “Apple|iPad|iOS”. The set of individuals tray be the consumer or the user. In some embodiments, the one or more entity devices 104A-N include, but are not limited to, a mobile device, a smartphone, a smart watch, a notebook, a Global Positioning System (GPS) device, a tablet, a desktop computer, a laptop or any network enabled device that generates the location data streams.

In some embodiments, the one or more entity devices 104A-N may run the one or more smart mobile applications that are responsible to generate the location data streams. In some embodiments, the network 106 is at least one of a wired network, a wireless network, a combination of the wired network and the wireless network or the Internet.

The POI clustering server 108 may be configured to generate a location mapping of the one or more entities 102A-N with a geographical area using one or more location data streams that are associated with the one or more of entities 102A-N. The location mapping provides an ambient population of the geographical area and a common evening location of the one or more entities 102A-N. The one or more location data streams are obtained from independently controlled data sources, where the location data streams include a real-time event with additional information including device attributes, connection attributes, and user agent strings. A connection attribute is a connection-indicative signal that may be generated at the one or more entity devices 104A-N. The connection attribute may be indicative of a presence or a characteristic of a connection between the one or more entity devices 104A-N and at least one other entity device of the one or more entity devices 104A-N or a server. The one or more connection attributes may include, but not be limited to, a connection type, an internet protocol address, and a carrier. For example, the one or more connection attributes may be “Cel14g,203.218.177.24,454-00”. The user agent strings contain a number of tokens that refer to various aspects of a request from the one or more entity devices 104A-N to the server, including a browser name and a browser version, a rendering engine, the model number attribute of the one or more entity devices 104A-N, the operating system. For example, the user agent strings may be (a) “Mozilla/5.0 (Linux; Android 6.0; S9_N Build/MRA58K; wv)”, (b) “AppleWebKit/537.36 (KHTML, like Gecko) Version/4.0”, (c) “Chrome/84.0.4147.125” and (d) “Mobile Safari/537.36”. Engagement of the one or more entity devices 104A-N with wi-fi hotshots may be tracked using location data streams that may be obtained from the different independently controlled data sources which may include telecom operators or smart mobile application data aggregators. The location data stream is the event or the sequence of events associated with time and location (longitude and latitude) and may also include additional payload information. The event or the sequence of events may be tracked by the different independently controlled data sources. For example, consider an entity 102A or a user using one or more smart mobile applications on an android phone associated with the entity 102A. As he or she interacts with each application, multiple independent streams of events may be produced and each application becomes an independent data source. Events and the one or more entity devices 104A-N may have different identifiers across different applications depending on how the smart mobile application is implemented. Additionally, if the network 106 were to be monitored, each smart mobile application-level event may generate additional lower-level network events.

In some embodiments, the independently controlled data sources may include (a) real-time bidding data that is an incoming data source that may be used for targeting an entity, (b) software development kit data that provides increased control, accuracy, and trust in the location data streams, and (c) third-party data sources that include app graph and professional data that may be used to enrich and build device signatures, or a list of normalized device models.

The POI clustering server 108 may be configured to determine, for each of the one or more POIs, visitor entities among the one or more entities 102A-N to record a footfall of each of the one or more POIs. The visitor entities of a POI are the entities that visit the POI. The POI clustering server 108 may be configured to dynamically assign catchment areas for each of the one or more POIs using the footfall and the location mapping. The POI clustering server 108 may be configured to determine segments of the visitor entities for each of the one or more POIs based on an offline behaviour and an online behaviour of the visitor entities. The POI clustering server 108 may be configured to automatically approximate an error in the footfall to improve a footfall model. The footfall model estimates a threshold that offsets the footfall to obtain an improved footfall of each of the one or more POIs.

The POI clustering server 108 may be configured to determine a segment opportunity value for each of the one or more POIs. The segment opportunity value is a function of (a) the improved footfall, (b) the ambient population of each of the one or more POIs, (c) the segments of the visitor entities, and (d) nearby POIs. The POI clustering server 108 may be configured to cluster the one or more POIs that have similar catchment areas based on the segment potential value and the improved footfall POI are the entities that visit the POI.

FIG. 2 is a block diagram of the POI clustering server 108 of FIG. 1 according to some embodiments herein. The POI clustering server 108 includes a database 202, the location mapping module 204, the visitor entities module 206, the catchment area module 208, the entity segmentation module 210, the error approximation module 212, the segment opportunity module 214, and the POI clustering module 216. the database 202 stores the plurality of location data streams that are obtained from independently controlled data sources, where the location data streams include a real-time event with additional information including device attributes, connection attributes, and user agent strings. the location mapping module 204 is configured to generate, using one or more location data streams that are associated with the one or more of entities 102A-N, a location mapping of the one or more entities 102A-N with a geographical area. The location mapping provides an ambient population of the geographical area and a common evening location of the plurality of entities 102A-N.

The visitor entities module 206 is configured to determine, for each of the plurality of POIs, visitor entities among the one or more entities to record a footfall of each of the plurality of POIs. The visitor entities of a POI are the entities that visit the POI.

The catchment area module 208 is configured to dynamically assign catchment areas for each of the one or more POIs using the footfall acid the location mapping. The entity segmentation module 210 is configured to determine segments of the visitor entities for each of the one or more POIs based on an offline behaviour and an online behaviour of the visitor entities. The catchment area module 208 utilizes home locations of the one or more entities to build a dynamic geo-fence for every POI as the catchment area. In some embodiments, the dynamic geo-fence is extrapolated for generating prospective entities for the POI as described in the table below

| | Footfalls | Home Location | Prospective Entities |
|---|---|---|---|
| POI P1 | X1 | HL1 | NP1 |
| | X2 | HL2 | NP2 |
| | . . . | . . . | . . . |
| | Xₙ | HLₙ | NPₙ |

For a POI, entities of a particular segment that have visited the POI are identified. This step is performed for each of the one or more POIs and footfall of respective segments of visitor entities is recorded. Entities that are associated with the same segment and living in the catchment area of the POI are identified. For a geographically crowded area where there is more than one POI, a non-visitor entity for a first POI might be a visitor entity to a second POI of the same brand in a nearby area. In some embodiments, a list of unique non-visitors is generated using location data streams associated with each of the one or more POIs to mitigate repetition in the counting of new prospective entities for the POI.

The error approximation module 212 is configured to automatically approximate an error in the footfall to improve a footfall model. The footfall model estimates a threshold that offsets the footfall to obtain an improved footfall of each of the one or more POIs. In some embodiments, the footfall model may include, but is not limned to, Random Forests, Prophet, DeepAR, LSTM/RNNs, Generative Adversarial Systems, Convolutional Neural Systems, Quantile Regressions, Bayesian Regressions, Factorization Machines, Bayesian Structural Time Series Models, Hidden Markov Models, and Monte Carlo Markov Chains.

The POI clustering server 108 may mitigate the delta of the improved footfall up to 50% of the footfall that is recorded. If the actual footfalls of a POI are 10% higher than the recorded footfalls, the POI clustering server 108 offsets the new delta using a weighted average approach of different signals and predicts the segment potential value per POI accurately. Signals such as current footfalls, population density, historic footfalls delta, and nearby similar category stores are considered. The following equation describes determining the segment potential value:
Segment Potential Value=w1(overall footfalls)+w2(nearby competitor stores)+w3(population density)+w4(current segment footfalls)+w5(new prospects), where w1, w2, w3, w4 and w5 are weights associated parameters overall footfalls, nearby competitor stores, population dens current segment footfalls and new prospects, respectively.

The segment opportunity module 214 is configured to determine a segment opportunity value for each of the one or more POIs. The segment opportunity value is a function of (a) the improved footfall, (b) the ambient population of each of the one or more POIs, (c) the segments of the visitor entities, and (d) nearby POIs. The POI clustering module 216 is configured to cluster the one or more POIs that have similar catchment areas based on the segment potential value and the improved footfall. In some embodiments, the segment opportunity value for a POI may determine a retail potential of the POI. The retail potential is a function of existing footfalls, vicinity population density, audience profile, home-locations timelines, catchment area, country geography, and other POIs within the vicinity of the subject POI. A catchment area or trade area is an area around the POI that is catered to by the POI for consumer goods. The catchment area is determined based on parameters including country geography, the size of the business of the POI or a particular retail store, the average distance traveled by an entity to reach the store, presence of several branches of a POI in the vicinity of each other and the availability of a particular segment of people living in the nearby area. For example, a radius of 5 km may be selected as the catchment area for a POI located in the United States which is less densely populated in comparison to Singapore, where a radius of 1 km may be selected as the catchment area for the POI. In some embodiments, the catchment area of nearby POIs may be excluded from the catchment area of a POI that is located in a densely populated geography.

In some embodiments, data from both offline and online data sources are used to categorize device identifiers associated with the one or more entities into different profiles. For example, people living in high-income residential areas and having luxury automotive apps installed on their devices are classified as ‘affluents’. Characterization of segments of the one or more entities, as an example, is described in the table below.

| | Places Category | Audience A | Audience B | Audience C |
|---|---|---|---|---|
| POI | High end Salon | | X | |
| Visit | Discount Retailer | X | | |
| | High-end Restaurant | | X | X |
| | Schools/Daycare | X | | X |

In some embodiments, entities associated with the improved footfall are tagged to the nearby POIs based on the catchment area of the POI. In some embodiments, though new prospective entities are a list of unique non-visitor entities, one non-visitor entity may be included in a segment potential list of more than one POI.

In some embodiments, the POI clustering server 108 generates a list of unique visitor entities for each of the plurality of POIs and assigns catchment areas based on the common evening location of the list of unique visitor entities, the average distance travelled by the list of unique visitor entities to visit each of the plurality of POIs and POIs nearby to the common evening location of the list of unique visitor entities.

In some embodiments, the POI clustering server 108 generates a list of unique non-visitors that have not visited the one or more POIs or are repeat visitors of the one or more POIs and updates the improved footfall using the list of unique non-visitors based on the catchment areas.

In some embodiments, a bias is eliminated in the footfall model. The bias is introduced due to a business size of a POI that causes a POI with lower improved footfall to have a lower segment potential value. Removing the bias that may have been introduced by the business size of a POI results in POIs with lower footfall not always having lower scores for prospective entities.

In some embodiments, the segment opportunity value for each of the one or more POIs is determined using a drive distance of the visitor entities to each of the one or more POIs, the improved footfall, a dwell-time of the visitor entities in each of the one or more POIs, a visit frequency, a segment characteristic of the segments of the visitor entities and the common evening locations of the visitor entities.

In some embodiments, the segment opportunity value for each of the one or more POIs is determined using a weighted average approach based on attributes of the one or more entities. The attributes include a distance travelled attribute, an affinity attribute, a purchase window attribute, an income attribute, anti an age attribute.

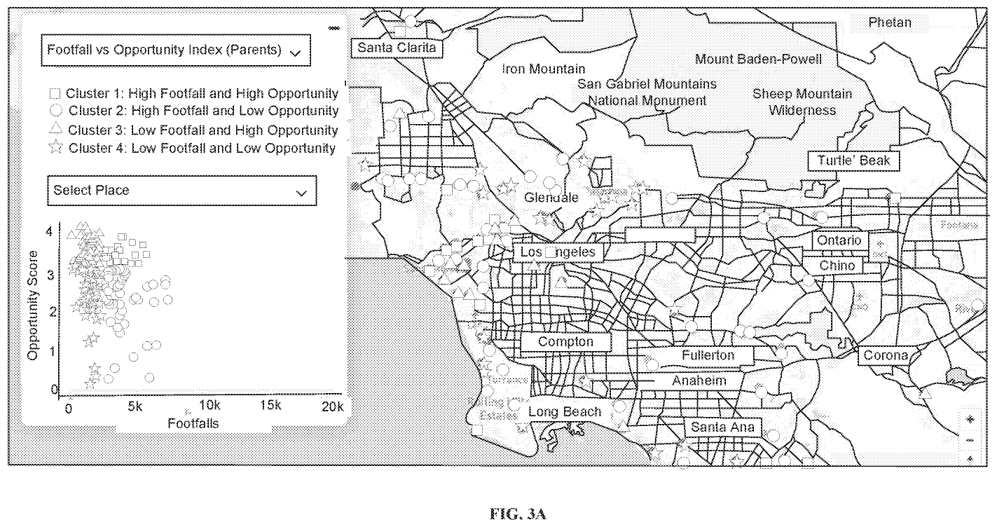

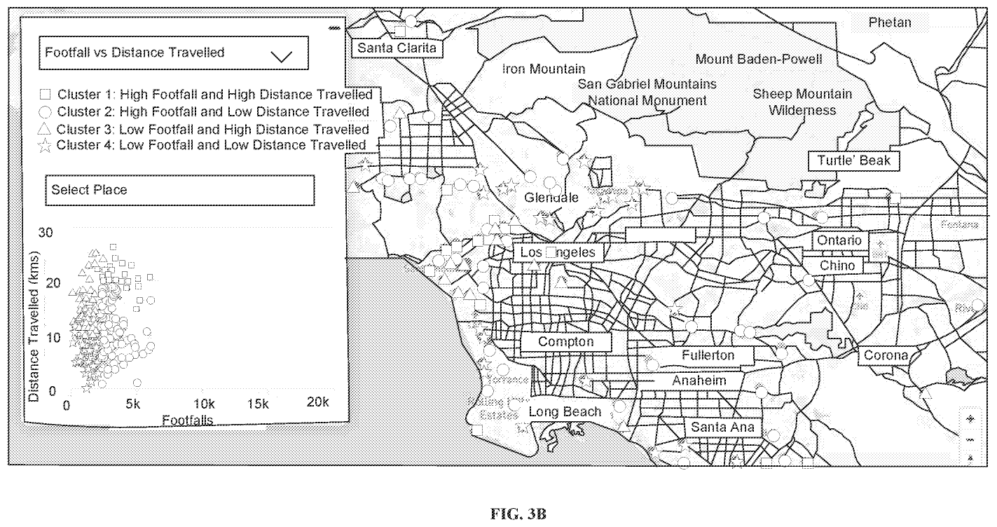

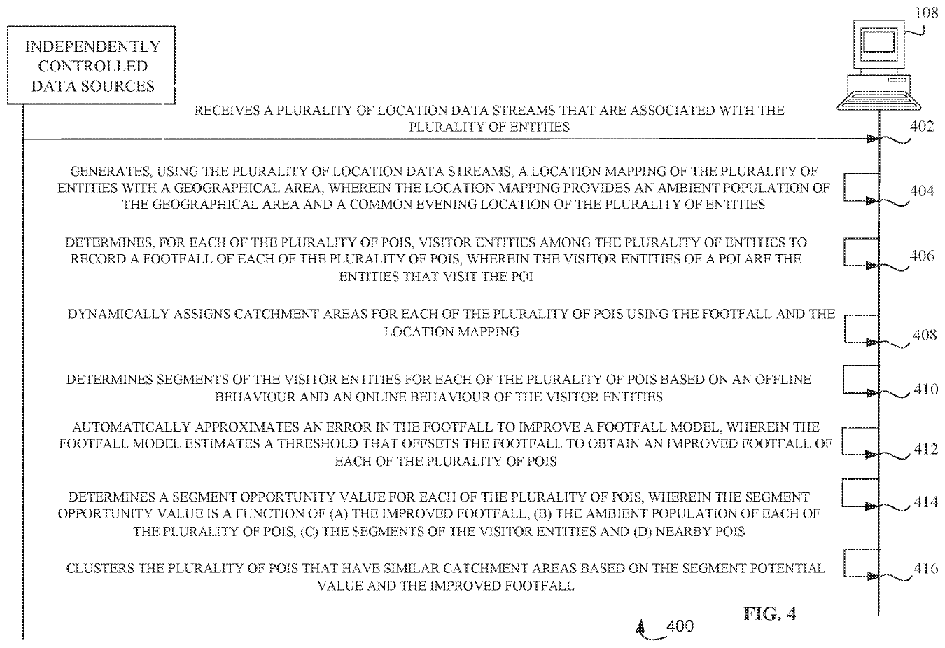

In some embodiments, after determining the segment potential value for each of the plurality of POIs, similar POIs are clustered together based on the characteristics of the footfall. The number of clusters may expand with the introduction of new parameters that are relevant to the business, and the distribution of the underlying data. Two-dimensional scatter plots that help a user of the POI clustering server 108 to create a distinction between the group of stores and make effective data-driven decisions are illustrated in FIGS. 3A-3B

FIG. 3A is a two-dimensional scatter plot that illustrates footfall vs segment opportunity value for the plurality of POIs, according to some embodiments herein. Cluster 1 is marked by square symbols and denotes high footfall and high opportunity, Cluster 2 is marked by circle symbols and denotes high footfall and low opportunity, Cluster 3 is marked by triangle symbols and illustrates low footfall and high opportunity, and Cluster 4 is marked by star symbols and denotes low footfall and low opportunity.

FIG. 3B is a two-dimensional scatter plot that illustrates footfall vs distance travelled for the plurality of POIs, according to some embodiments herein. Cluster 1 is marked by square symbols and denotes high footfall and high distance travelled, Cluster 2 is marked by circle symbols and denotes high footfall and low distance travelled, Cluster 3 is marked by triangle symbols and illustrates low footfall and high distance travelled, and Cluster 4 is marked by star symbols and denotes low footfall and low distance travelled.

FIG. 4 illustrates an interaction diagram 400 of a method for identifying the entity device using the device signature of the entity device and the location signature of the location according to some embodiments herein. At step 402, a plurality of location data streams that are associated with the plurality of entities is received. At step 404, a location mapping of the plurality of entities with a geographical area is generated using the plurality of location data streams, wherein the location mapping provides an ambient population of the geographical area and a common evening location of the plurality of entities. At step 406, for each of the plurality of POIs, visitor entities among the plurality of entities are determined to record a footfall of each of the plurality of POIs, wherein the visitor entities of a POI are the entities that visit the POI. At step 408, catchment areas for each of the plurality of POIs are dynamically assigned using the footfall and the location mapping. At step 410, segments of the visitor entities are determined for each of the plurality of POIs based on an offline behaviour and an online behaviour of the visitor entities. At step 412, an error in the footfall is automatically approximated to improve a footfall model, wherein the footfall model estimates a threshold that offsets the footfall to obtain an improved footfall of each of the plurality of POIs. At step 414, a segment opportunity value is determined for each of the plurality of POIs, wherein the segment opportunity value is a function of (a) the improved footfall, (b) the ambient population of each of the plurality of POIs, (c) the segments of the visitor entities and (d) nearby POIs. At step 416, the plurality of POIs that have similar catchment areas are clustered based on the segment potential value and the improved footfall.

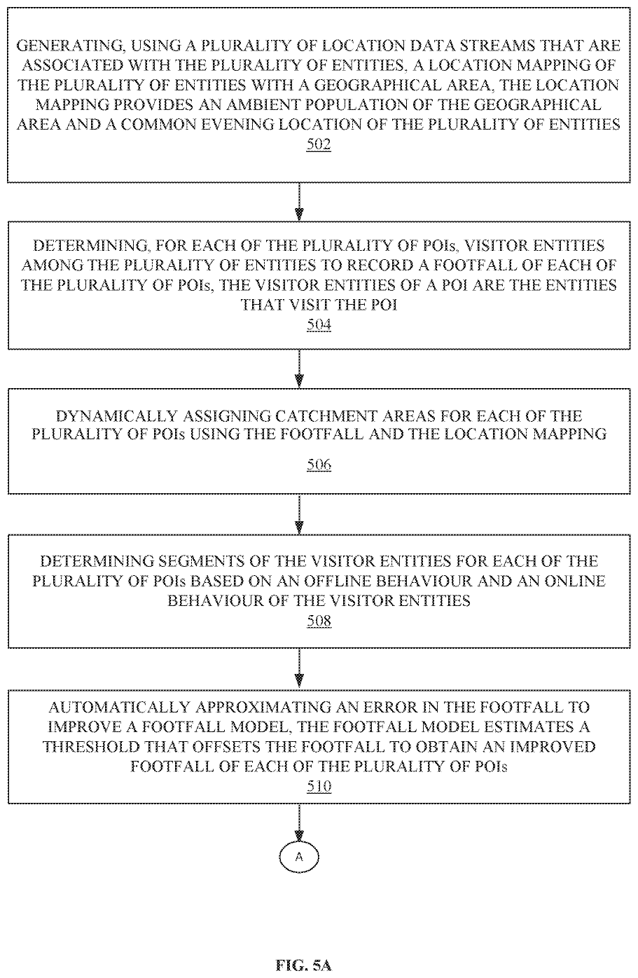

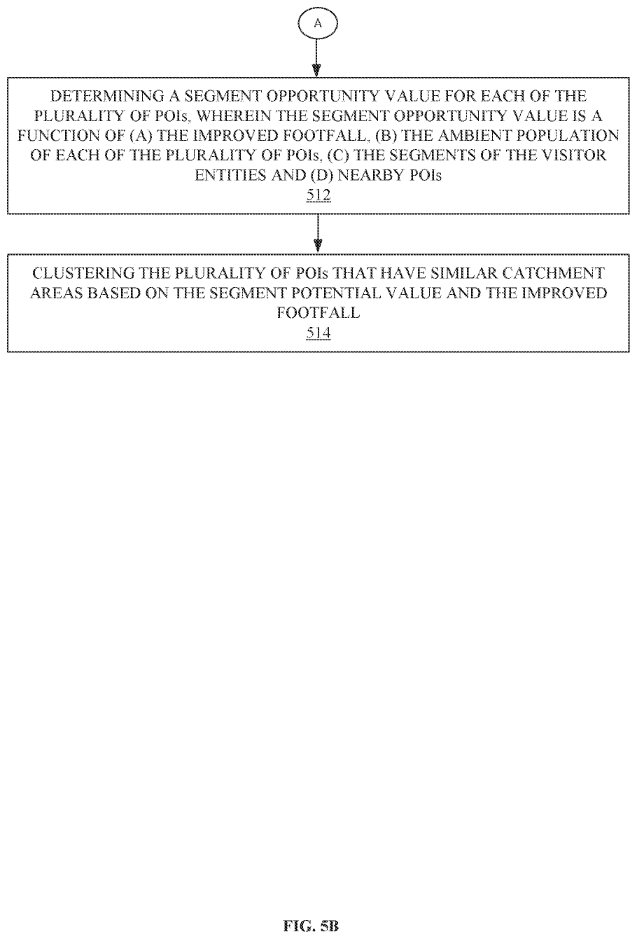

FIGS. 5A and 5B are flow diagrams of a method for identifying the entity device using a device signature of the entity device and a location signature of the location according to some embodiments herein. At step 502, the method includes generating, using a plurality of data streams of location fixes that are associated with the plurality of entities, a location mapping of the plurality of entities with a geographical area, wherein the location mapping provides an ambient population of the geographical area and a common evening location of the plurality of entities. At step 504, the method includes determining, for each of the plurality of POIs, visitor entities among the plurality of entities to record a footfall of each of the plurality of POIs, wherein the visitor entities of a POI are the entities that visit the POI. At step 506, the method includes dynamically assigning catchment areas for each of the plurality of POIs using the footfall and the location mapping. The plurality of location data streams comprises a timestamp data and at least one location attribute. At step 508, the method includes determining segments of the visitor entities for each of the plurality of POIs based on an offline behaviour and an online behaviour of the visitor entities. At step 510, the method includes automatically approximating an error in the footfall to improve a footfall model, wherein the footfall model estimates a threshold that offsets the footfall to obtain an improved footfall of each of the plurality of PO's. At step 512, the method includes determining a segment opportunity value for each of the plurality of POIs, wherein the segment opportunity value is a function of (a) the improved footfall, (b) the ambient population of each of the plurality of POIs, (c) the segments of the visitor entities and (d) nearby POIs. At step 514, the method includes clustering the plurality of POIs that have similar catchment areas based on the segment potential value and the improved footfall.

The method provides a scalable model for clustering the one or more POIs. Further, the segment opportunity value enables a person associated with the POI to strategize inventory planning among the distribution channels of the POI.

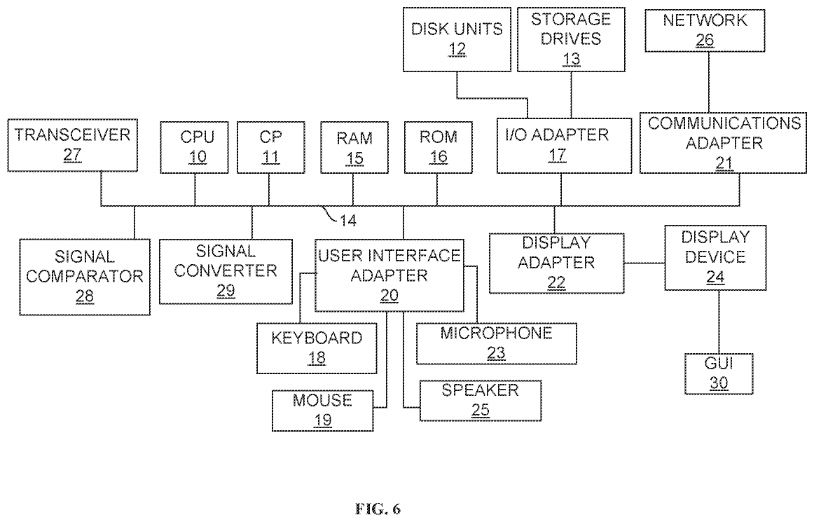

A representative hardware environment for practicing the embodiments herein is depicted in FIG. 6, with reference to FIGS. 1 through 5B. This schematic drawing illustrates a hardware configuration of a server or a computer system or a computing device in accordance with the embodiments herein. The system includes at least one processing device CPU 10 that may be interconnected via system bus 14 to various devices such as a random-access memory (RAM) 12, read-only memory (ROM) 16, and an input/output (I/O) adapter 18. The UO adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and other user interface devices such as a touch screen device (not shown) to the bus 14 to gather user input. Additionally, a communication adapter 20 connects the bus 14 to a data processing network 42, and a display 75 adapter 24 connects the bus 14 to a display device 26, which provides a graphical user interface (GUI) 36 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify an adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. A method of clustering of a plurality of place of interest (POIs) using segment characterization and common evening locations of a plurality of entities, said sequence of instructions comprising:
generating, using a plurality of data streams of location fixes that are associated with the plurality of entities, a location mapping of the plurality of entities with a geographical area, wherein the location mapping provides an ambient population of the geographical area and a common evening location of the plurality of entities;
determining, for each of the plurality of POIs, visitor entities among the plurality of entities to record a footfall of each of the plurality of POIs, wherein the visitor entities of a POI are the entities that visit the POI;
dynamically assigning catchment areas for each of the plurality of POIs using the footfall and the location mapping;
determining segments of the visitor entities for each of the plurality of POIs based on an offline behaviour and an online behaviour of the visitor entities;
automatically approximating an error in the footfall to improve a footfall model, wherein the footfall model estimates a threshold that offsets the footfall to obtain an improved footfall of each of the plurality of POIs;
determining a segment opportunity value for each of the plurality of POIs, wherein the segment opportunity value is a function of (a) the improved footfall, (b) the ambient population of each of the plurality of POIs, (c) the segments of the visitor entities and (d) nearby POIs; and
clustering the plurality of POIs that have similar catchment areas based on the segment potential value and the improved footfall.

2. The method of claim 1, wherein the plurality of location data streams are obtained from independently controlled data sources, wherein the location data streams include a real-time event with additional information including device attributes, connection attributes and user agent strings.

3. The method of claim 1, further comprising:
generating a list of unique visitor entities for each of the plurality of POIs; and
assigning catchment areas based on the common evening location of the list of unique visitor entities, average distance travelled by the list of unique visitor entities to visit each of the plurality of POIs and POIs nearby to the common evening location of the list of unique visitor entities.

4. The method of claim 3, further comprising:
generating a list of unique non-visitors that have not visited the plurality of POIs or are repeat visitors of the plurality of POIs; and
updating the improved footfall using the list of unique non-visitors based on the catchment areas.

5. The method of claim 1, further comprising eliminating a bias in the footfall model, wherein the bias is introduced due to a business size of a POI that causes a POI with lower improved footfall to have a lower segment potential value.

6. The method of claim 1, wherein the segment opportunity value for each of the plurality of POIs is determined using a drive distance of the visitor entities to each of the plurality of POIs, the improved footfall, a dwell-time of the visitor entities in each of the plurality of POIs, a visit frequency, a segment characteristic of the segments of the visitor entities and the common evening locations of the visitor entities.

7. The method of claim 1, further comprising determining the segment opportunity value for each of the plurality of POIs using a weighted average approach based on attributes of the plurality of entities, wherein the attributes include a distance travelled attribute, an affinity attribute, a purchase window attribute, an income attribute, and an age attribute.

8. A place of interest (POI) clustering server that clusters a plurality of POIs using segment characterization and common evening locations of a plurality of entities, said server comprising:
a processor; and
a memory that stores a set of instructions, which when executed by the processor, causes it to perform:
generating, using a plurality of location data streams that are associated with the plurality of entities, a location mapping of the plurality of entities with a geographical area, wherein the location mapping provides an ambient population of the geographical area and a common evening location of the plurality of entities;
determining, for each of the plurality of POIs, visitor entities among the plurality of entities to record a footfall of each of the plurality of POIs, wherein the visitor entities of a POI are the entities that visit the POI;
dynamically assigning catchment areas for each of the plurality of POIs using the footfall and the location mapping;
determining segments of the visitor entities for each of the plurality of POIs based on an offline behaviour and an online behaviour of the visitor entities;
automatically approximating an error in the footfall to improve a footfall model, wherein the footfall model estimates a threshold that offsets the footfall to obtain an improved footfall of each of the plurality of POIs;
determining a segment opportunity value for each of the plurality of POIs, wherein the segment opportunity value is a function of (a) the improved footfall, (b) the ambient population of each of the plurality of POIs, (c) the segments of the visitor entities and (d) nearby POIs; and
clustering the plurality of POIs that have similar catchment areas based on the segment potential value and the improved footfall.

9. The POI clustering server of claim 8, wherein the plurality of location data streams are obtained from independently controlled data sources, wherein the location data streams include a real-time event with additional information including device attributes, connection attributes, and user agent strings.

10. The POI clustering server of claim 8, further comprising:
generating a list of unique visitor entities for each of the plurality of POIs; and
assigning catchment areas based on the common evening location of the list of unique visitor entities, average distance travelled by the list of unique visitor entities to visit each of the plurality of POIs and POIs nearby to the common evening location of the list of unique visitor entities.

11. The POI clustering server of claim 10, further comprising:
generating a list of unique non-visitors that have not visited the plurality of POIs or are repeat visitors of the plurality of POIs; and
updating the improved footfall using the list of unique non-visitors based on the catchment areas.

12. The POI clustering server of claim 8, further comprising eliminating a bias in the footfall model, wherein the bias is introduced due to a business size of a POI that causes a POI with lower improved footfall to have a lower segment potential value.

13. The POI clustering server of claim 8, wherein the segment opportunity value for each of the plurality of POIs is determined using a drive distance of the visitor entities to each of the plurality of POIs, the improved footfall, a dwell-time of the visitor entities in each of the plurality of POIs, a visit frequency, a segment characteristic of the segments of the visitor entities and the common evening locations of the visitor entities.

14. The POI clustering server of claim 8, further comprising determining the segment opportunity value for each of the plurality of POIs using a weighted average approach based on attributes of the plurality of entities, wherein the attributes include a distance travelled attribute, an affinity attribute, a purchase window attribute, an income attribute, and an age attribute.

15. A non-transitory computer-readable storage medium storing a sequence of instructions, which when executed by a processor, causes clustering of a plurality of place of interest (POIs) using segment characterization and common evening locations of a plurality of entities, said sequence of instructions comprising:
generating, using a plurality of location data streams that are associated with the plurality of entities, a location mapping of the plurality of entities with a geographical area, wherein the location mapping provides an ambient population of the geographical area and a common evening location of the plurality of entities;
determining, tier each of the plurality of POIs, visitor entities among the plurality of entities to record a footfall of each of the plurality of POIs, wherein the visitor entities of a POI are the entities that visit the POI;
dynamically assigning catchment areas for each of the plurality of PO s using the footfall and the location mapping;
determining segments of the visitor entities for each of the plurality of POIs based on an offline behaviour and an online behaviour of the visitor entities;
automatically approximating an error in the footfall to improve a footfall model, w, therein the footfall model estimates a threshold that offsets the footfall to obtain an improved footfall of each of the plurality of POIs;
determining a segment opportunity value for each of the plurality of POIs, wherein the segment opportunity value is a function of (a) the improved footfall, (b) the ambient population of each of the plurality of POIs, (c) the segments of the visitor entities and (d) nearby POIs; and
clustering the plurality of POIs that have similar catchment areas based on the segment potential value and the improved footfall.

16. The non-transitory computer-readable storage medium storing a sequence of instructions of claim 15, wherein the plurality of location data streams are obtained from independently controlled data sources, wherein the location data streams include a real-time event with additional information including device attributes, connection attributes, and user agent strings.

17. The non-transitory computer-readable storage medium storing a sequence of instructions of claim 15, further comprising:
generating a list of unique visitor entities for each of the plurality of POIs; and
assigning catchment areas based on the common evening location of the list of unique visitor entities, an average distance travelled by the list of unique visitor entities to visit each of the plurality of POIs and POIs nearby to the common evening location of the list of unique visitor entities.

18. The non-transitory computer-readable storage medium storing a sequence of instructions of claim 15, further comprising:
generating a list of unique non-visitors that have not visited the plurality of POIs or are repeat visitors of the plurality of POIs; and
updating the improved footfall using the list of unique non-visitors based on the catchment areas.

19. The non-transitory computer-readable storage medium storing a sequence of instructions of claim 15, further comprising eliminating a bias in the footfall model, wherein the bias is introduced due to a business size of a POI that causes a POI with lower improved footfall to have a lower segment potential value.

20. The non-transitory computer-readable storage medium storing a sequence of instructions of claim 15, further comprising determining the segment opportunity value for each of the plurality of POIs using a weighted average approach based on attributes of the plurality of entities, wherein the attributes include a distance travelled attribute, an affinity attribute, a purchase window attribute, an income attribute, and an age attribute.
